(19) United States
(12) Patent Application Publication
(10) Pub. No.: US 2003/0065735 A1
(43) Pub. Date: Apr. 3, 2003

(54) Method and apparatus for transferring packets via a network

(76) Inventor: Patrick L. Connor, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/970,175

(22) Filed: Oct. 2, 2001

(51) Int. Cl. G06F 15/16

(52) U.S. Cl. 709/212; 709/250

(57) ABSTRACT

Embodiments of a method and apparatus for receiving packets via a network are described.

### BACKGROUND

This disclosure is related to transmitting and/or receiving packets via a network.

A computing platform or device, e.g. a device that handles, stores, displays and/or processes data, such as a computer, may transmit and receive data and/or information in packet format between itself and another device over a communications network. The computing device may include a host memory as well as a local bus coupled to a network adapter. A communications network may include a plurality of interconnected nodes, and may comprise, for example, without limitation, computers, set top boxes, peripherals, servers and/or terminals coupled by communications lines or other communications channels. A Communications network may connect or couple nodes over a local area, such as, for example, a campus, or over a wide area, such as, for example, multiple campuses. A network Adapter, also generally known as a network controller or network interface card (NIC), may be coupled to a computing device and used to process data received from and/or transmitted to a communications channel.

Such a network adapter may include its own local memory, an input/output (I/O) controller, and a network transceiver. High-speed I/O controllers are often throughput limited at least in part due to the local bus of the computing device. For example, the peripheral component interconnect (PCI) specification, rev. 2.1, issued Jun. 1, 1995, available from www.pcisig.com, describes, in part, associated overhead for memory transfers. A computing device may transfer signals in a manner that complies with this specification. In such a case, memory transfer operations, such as a direct memory access (DMA) bus transaction, for example, may be inefficient small transfers, such as less than about 1K bytes of data. Ethernet data packets based at least in part on ANSI/IEEE Std. 802.3ab, published in 2000, typically vary from 64 to 1518 bytes in length. However, the majority of Ethernet data packets tends to be small. As previously indicated, memory transfers of these packets may be inefficient where the signals employed comply with the PCI specification, for example. A need, therefore, is present to address the inefficiency associated with this transfer of relatively small data packets from a communications network to a host memory.

### BRIEF DESCRIPTION OF THE DRAWINGS

Subject matter is particularly pointed out and distinctly claimed in the concluding portion of the specification. The subject matter, however, both as to organization and method of operation, together with objects, features, and advantage thereof, may best be understood by reference of the following detailed description when read with the accompanying drawings in which:

FIG. 1 is a block diagram illustrating one embodiment of a system including a computing device coupled to a network adapter;

FIG. 2 is a block diagram illustrating descriptors in one embodiment;

FIG. 3 is a flow chart illustrating initialization of a computing device and a network adapter in one embodiment; and

FIG. 4 is a flowchart illustrating reception of an ingress packet in one embodiment.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail in order so as not to obscure the claimed subject matter.

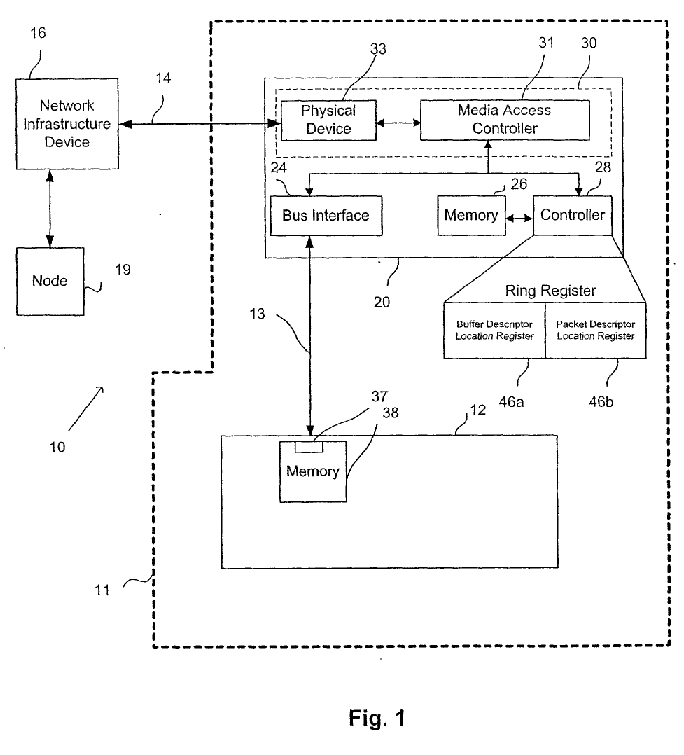

Although the claimed subject matter is not limited in scope in this respect, FIG. 1 illustrates one embodiment 10 of a communications network including network nodes 11 and 19. Node 11, for example, includes a computing device 12 coupled via an I/O bus 13 to a network adapter 20, although the claimed subject matter is not limited in scope. Furthermore, device 12 may be any device, machine, computer or processor, such as one that handles, routes, or processes information. Adapter 20, for example, may be integrated into node 11 with computing device 12 or alternatively may be separate from computing device 12 and comprises multiple operational units, such as 24-33, as described in more detail hereinafter. Likewise, adapter 20 may comprise a single integrated circuit (IC), multiple ICs or may be integrated into circuitry within computing device 12. These are just a few examples of the possible architecture of node 11. The claimed subject matter is, of course, not limited in scope to employing a particular architecture.

Although the claimed subject matter is not limited in scope in this respect, in one embodiment, network adapter 20 may be coupled to node 19 via network media 14 and one or more network infrastructure devices (NIDs), such as NID 16. NID 16 may comprise, for example, any device capable of routing, switching, repeating or passing data on a network, examples of which may include, without limitation, a router, server, switch and/or hub. Network media 14 refers to the medium or media through which signals are transferred or transmitted including, but not limited to, optical fiber, cables, and/or radio waves.

In a network adapter, the I/O controller may include the capability to read scatter-gather descriptors stored in the host memory of the computing device. Scatter-gather descriptors, or, simply, descriptors, in this context, refer to data in memory that provide information about packets or data packets stored elsewhere in memory that are to be transmitted to or that have been received from the communications network. These may be included in a table, although this is not necessary, of course. The descriptors typically comprise details (e.g., address, length, control information, etc.) about the data packets. For example, a block of memory, referred to here as a buffer, may be allocated to store such data packets. These descriptors may thus include, for example, information about the location of the buffer in memory.

A network adapter may read the descriptors to determine what memory transfer operations, such as direct memory access (DMA) bus transactions, for example, to perform via the local bus in order to complete the desired transmit and/or receive operation or operations. For example, a device driver on the computing device may form the scatter-gather descriptors to include the address, length, and control information about a packet or packets to be transmitted. By one of many possible methods, the I/O controller may fetch these descriptors and may then initiate memory transfers of data packets within buffers referenced by these scatter-gather descriptors. During a memory transfer, such as by a DMA device, the device may request control of the local bus and read a sequence of data from a buffer of memory and write this data into a local memory within the network adapter. After the data has been fetched, the I/O controller may then transfer the data packet or packets to the network transceiver for transmission onto the communications network. For receive operations, the device driver may generate descriptors that indicate to the I/O controller available buffer locations within the host memory of the computing device. The I/O controller may write the received packets into these buffers. After the memory or DMA transfer operation is complete, the I/O controller may update the descriptors to indicate to the device driver the status of the data packet or packets that now occupy the buffers.

Scatter-gather descriptors may generally be placed in an array or linked list. The descriptors are typically used in a circular fashion, such as by reading a first descriptor, continuing to read the descriptors until a final one is read, then reading the first descriptor again. These groups of descriptors in this context are referred to as descriptor rings, although, of course, the claimed subject matter is not limited in scope to employing such rings. There may be separate rings for egress and ingress operations, although, again, the claimed subject matter is not limited in scope in this respect. An egress operation in this context refers to the data packet transmission process and an ingress operation in this context refers to the data packet reception process.

As shown in FIG. 1, device 12 may include a host memory 38 that may have stored therein ingress packets and/or egress packets. As just explained, egress packets are packets of data to be transferred or transmitted from device 12 via media 14 to the network, and ingress packets are packets of data to be received by device 12 via media 14 from the network.

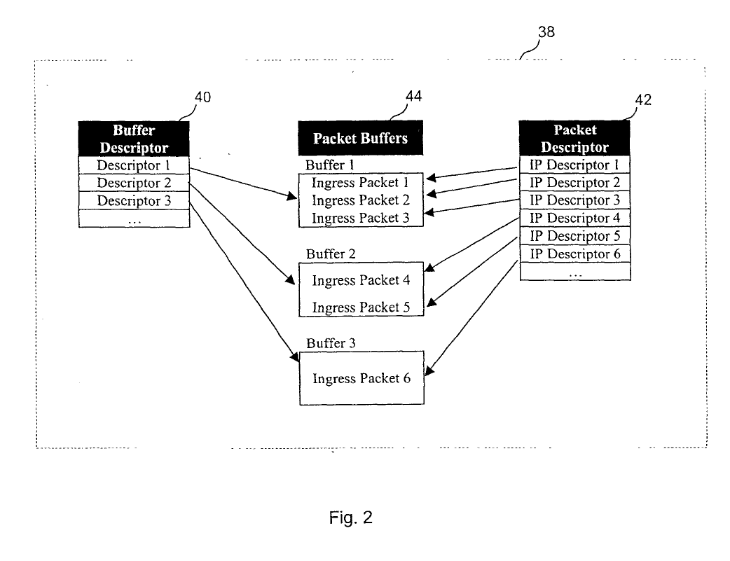

The ingress packets themselves that are received may be stored within memory 38 in packet buffers 44, shown, for example, in FIG. 2. Memory 38 may also contain buffer descriptors 40, and packet descriptors 42, as shown in FIG. 2 and described in more detail hereinafter. Buffer descriptors 40 may be descriptors that indicate the locations of buffers in memory 38 allocated for ingress packet storage. Packet descriptors 42, on the other hand, may be descriptors that indicate those locations within the allocated buffers that contain the stored ingress packets.

Network adapter 20 may read data from memory 38 via bus 13 and transfer such data as egress packets across network media 14. Likewise, network adapter 20 may receive data as ingress packets via network media 14 and may write the ingress packets into memory 38 via bus 13. Device 12 may include program code, including, but not limited to, an operating system (OS) and a device driver, such as 37. Typically these instructions are stored in a memory, such as memory 38. Typically, device 12, while executing the OS, may store data to be transmitted as egress packets in memory 38. The OS may thus provide an indication that such data is available for transfer. Of course, this is a description of only one possible embodiment and the claimed subject matter is not limited in scope to this particular embodiment.

In one embodiment, network adapter 20 comprises an integrated circuit (IC), the IC including a controller 28, here coupled to a bus interface 24, a network adapter or local memory 26 and a transceiver 30. Transceiver 30 may include a media access controller (MAC) or MAC layer 31 and a physical device or physical layer 33. Transceiver 30, of course, may read egress packets stored in memory 26 from memory 26 to be transmitted via media 14, and may store or write into memory 26 ingress packets received from media 14.

Controller 28 may include a computational device, such as, for example, but not limited to, a state machine, an arithmetic logic unit (ALU) or a processor that is capable of performing arithmetic computations. In this particular embodiment, the computational device may be employed to measure or estimate a volume of traffic passing through media 14. Controller 28 may monitor media 14 via transceiver 30 and measure or estimate the volume of network traffic being transmitted and/or received, for example. In this context, network traffic or network signal traffic refers to a measure of the utilization of the network for signal transmission by the devices coupled to it relative to the available bandwidth capability of the network. For example, one measure of network traffic may include the number of data packets that are passed via media 14 to and from device 12 in a predetermined period of time, although other measures may also or alternatively be employed and are within the scope of the claimed subject matter.

In one embodiment, controller 28 may determine a “light” network traffic condition, such as when the measured volume of network traffic is below a predetermined threshold. Controller 28 may also determine a “heavy” network traffic condition, such as when the measured volume of network traffic exceeds such a predetermined threshold. The predetermined threshold may be set or determined by any one of a number of methods or techniques, such as by the user, at the factory, or computed by the network adapter or the computing device in real-time, for example. Again, this is intended simply as an example of a possible embodiment and the claimed subject matter is not limited in scope in this respect.

Controller 28 may transfer ingress and/or egress packets stored in memory 26 through interface 24, across bus 13 to and from memory 38, respectively, using memory transfer operations, such as DMA bus transactions, for example. As previously indicated, buffer descriptors 40 and packet descriptors 42 are illustrated in FIG. 2 and are described in more detail hereinafter. As illustrated in FIG. 1, controller 28 may include a buffer descriptor location register 46a that indicates in this embodiment the length and location of buffer descriptors 40 in memory 38. Controller 28 may also include a packet descriptor location register 46b identifying the location and length of the packet descriptors 42 in memory 38, again, for this particular embodiment.

Referring to FIG. 2, in one embodiment, computing device 12, executing device driver 37, may generate buffer descriptors 40. Buffer descriptors 40 may indicate the locations within memory 38, here, the packet buffer locations, allocated for ingress packet storage, as well as the size or length of those locations. The length of a buffer may, in one embodiment, be a predetermined fixed value, such as one ranging from 2k to 4k bytes. Alternatively, such lengths may vary. In contrast with the buffer descriptors, controller 28 may generate packet descriptors 42, although the packet descriptors may be stored in memory 38 rather than on network adapter 20. The packet descriptors 42 may indicate the locations within memory 38 that contain ingress packets as well as the length of the stored ingress packets. The ingress packets, as indicated above, may be stored in packet buffers 44, however.

In one embodiment of the claimed subject matter, controller 28 may include a ring register, such as one that includes a buffer descriptor location register 46a and a packet descriptor location register 46b, as previously described. Buffer descriptor location register 46a and packet descriptor location register 46b in this particular embodiment may include the length and address of buffer descriptors 40 and packet descriptors 42 within memory 38.

During operation, therefore, in this embodiment, controller 28 may retrieve buffer descriptors 40 via bus interface 24. Buffer descriptors 40 here are retrieved from locations in memory 38 indicated by buffer descriptor location register 46a. Controller 28 may, then, in this Embodiment with a single memory transfer operation quickly transfer multiple ingress packets from memory 26 and transfer these ingress packets into locations within packet buffers 44 indicated by buffer descriptors 40. Controller 28 may then transfer, in this embodiment, using a single memory transfer operation, packet descriptors 42 into locations in memory 38 indicated by packet descriptor location register 46b to reflect the ingress packets just transferred to memory 38. Of course, the claimed subject matter is not limited in scope in this respect.

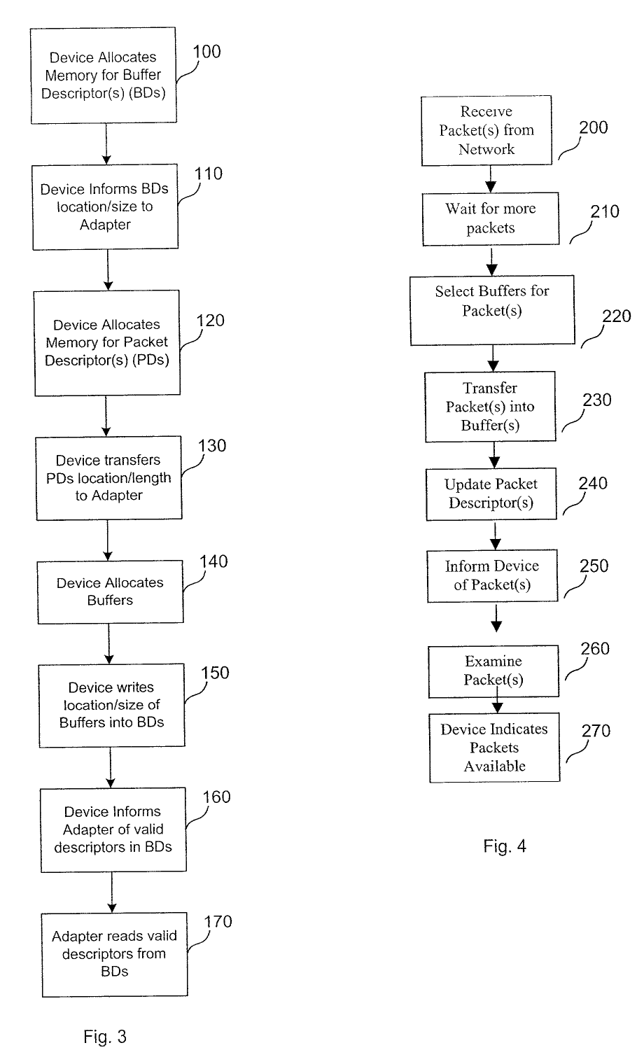

Referring to FIG. 3, a flowchart of an embodiment of a method for initialization of a computing device and network adapter is provided. In block 100, device 12 may allocate storage locations within memory 38 for buffer descriptors (BDs) 40. In block 110, device 12 may transfer the location and length of the BDs into register 46a in adapter 20. Device 12 may, in block 120, allocate locations in memory 38 for storage of the packet descriptors (PDs) 42. In block 130, device 12 may transfer the location and length of the PDs 42 to register 46b. In block 140, device 12 may allocate a plurality of buffers in memory 38 for storing ingress packets. In block 150, device 12 may transfer the location and length of the allocated buffers into BDs 40. In block 160, device 12 may inform controller 28 on network adapter 20 that there are valid descriptors in the locations for storing BDs. Device 12 may provide this indication, in this embodiment, for example, by writing a flag into an internal register (not shown) in controller 28 indicating a valid buffer description. In block 170, controller 28 on network adapter 20 may transfer from memory 38 the valid BDs and store the locations in register 46a. The valid BDs may contain both the length and location of packet buffers 44 allocated to store ingress packets.

Although not limited in scope in this respect, FIG. 4 is a flowchart illustrating one embodiment of a method for reception of an ingress packet. In block 200, transceiver 30 may receive an ingress packet via media 14. Controller 28 may transfer the received ingress packet into memory 26. Controller 28 in block 210 may delay starting a memory transfer operation that transfers the received ingress packet located within memory 26 to memory 38 to allow several ingress packets to be received and stored in memory 26. In block 220, controller 28 may determine the buffers in packet buffers 44 to store the received ingress packet(s). To do this, controller 28 may determine the remaining space available in the memory locations indicated by buffer descriptors 40 and how to accommodate the received packet(s). For example, controller 28 may determine to either write a portion of an ingress packet to the current buffer and the remainder of the ingress packet to the next available buffer, or may determine to transfer a packet to the next available buffer within packet buffers 44. In block 230, controller 28 using a memory transfer operation may transfer one or more of the received ingress packets into packet buffers 44. Subsequent ingress packets may not necessarily be received by transceiver 30 immediately after the first ingress packet is received. Controller 28 may, therefore, use a memory transfer operation to transfer ingress packets in memory 26 to a buffer containing no ingress packets within packet buffers 44 before utilizing a buffer containing ingress packets within packet buffers 44 to store additional ingress packets, although the claimed subject matter is not limited in scope in this respect.

As indicated previously, in one embodiment, controller 28 may monitor the quantity of network signal traffic via media 14, such as via MAC 31, for example. Controller 28 may determine when the quantity of such network signal traffic falls below a predetermined threshold and, in response thereto, may limit to the number of ingress packets to be transferred from adapter 20 to device 12 to the number of available buffers indicated by buffer descriptors 40, as described in more detail hereinafter.

Under light network traffic conditions, such as where a predetermined threshold is not exceeded, for example, controller 28 may, using a memory transfer operation, transfer one ingress packet to one buffer within packet buffers 44. If controller 28 determines that the measured volume of network traffic exceeds a predetermined threshold, such as in heavy network traffic conditions, it may group several ingress packets together in memory 26 and use a memory transfer operation to transfer multiple ingress packets to one buffer within packet buffers 44.

In block 240, controller 28 may transfer, using a memory transfer operation, descriptors for the stored ingress packets, including ingress packet length and location within packet buffers 44, into packet descriptors 42. Likewise, in one embodiment, controller 28 may include within the status information of a packet descriptor an indication of usage of packet buffers 44. An example of such an indication of buffer usage may include a packet buffer flag that indicates that a following ingress packet was placed in a next buffer within packet buffers 44, although the claimed subject matter is not limited in scope in this respect.

In block 250, controller 28 may send an interrupt to device 12 via bus 13 to inform device 12 that the received ingress packets have been transferred into packet buffers 44. The device may respond to the interrupt by reading an interrupt register on controller 28 to determine the cause of the interrupt. Alternately, the device may periodically poll memory 38 to determine that the received ingress packets have been transferred into packet buffers 44.

In block 260, device 12 may examine packet descriptors 42. In block 270, device 12 may provide the locations of the ingress packets in packet buffers 44 to its OS. The OS may then provide an indication to driver 37 that one or more of buffers within packet buffers 44 are available for storage of more ingress packets. Driver 37 may wait for an indication that all the buffers in packet buffers 44 are available for transfer of more ingress packets before providing an indication to controller 28 that buffers are available for use by subsequent ingress packets. Alternatively, driver 37 may track how many ingress packets are transferred to packet buffers 44 and which buffers within packet buffers 44 are available to receive more ingress packets.

It will, of course, be understood that, although particular embodiments have just been described, the claimed subject matter is not limited in scope to a particular embodiment or implementation. For example, one embodiment may be in hardware, whereas another embodiment may be in software. Likewise, an embodiment may be in firmware, or any combination of hardware, software, or firmware, for example. Likewise, although the claimed subject matter is not limited in scope in this respect, one embodiment may comprise an article, such as a storage medium. Such a storage medium, such as, for example, a CD-ROM, or a disk, may have stored thereon instructions, which when executed by a system, such as a computer system or platform, for example, may result in an embodiment of a method in accordance with the claimed subject matter being executed, such as an embodiment of transmitting multiple ingress packets, for example, as previously described. Where software or computer programs are involved, they may be implemented in a high level procedural or object oriented programming language to communicate with a processing system. The programs may also be implemented in assembly or machine language, if desired. The claimed subject matter is not limited in scope to any particular programming language. Likewise, the language may be a compiled or interpreted language.

In the preceding description, various aspects of the claimed subject matter have been described. For purposes of explanation, specific numbers, systems and configurations were set forth in order to provide a thorough understanding of the claimed subject matter. However, it is apparent to one skilled in the art having the benefit of this disclosure that the claimed subject matter may be practiced without the specific details. In other instances, well-known features were omitted or simplified in order not to obscure the claimed subject matter.

While certain features of the claimed subject matter have been illustrated and described herein, many modifications, substitutions, changes and equivalents will now occur to those skilled in the art. It is, therefore, to be understood that the appended claims are intended to cover all such modifications and changes as fall within the true spirit of the claimed subject matter.

1. An integrated circuit comprising:
a controller operative to retrieve from a host computing device memory one or more buffer descriptors that indicate one or more memory locations of the host memory available for storage, said controller operative to store one or more received ingress packets in the one or more memory locations indicated and to store one or more packet descriptors that indicate the location within the host memory of the one or more received ingress packets.

2. The integrated circuit of claim 1, wherein the controller is operative to store multiple ingress packets in multiple memory locations indicated by the buffer descriptors with a single memory transfer operation.

3. The integrated circuit of claim 2, wherein the memory transfer operation comprises a direct memory access (DMA) bus transaction.

4. The integrated circuit of claim 1, wherein the controller is operative to store the one or more packet descriptors into host memory using a single memory transfer operation.

5. The integrated circuit of claim 4, wherein the memory transfer operation comprises a direct memory access (DMA) bus transaction.

6. The integrated circuit of claim 1, wherein the one or more buffer descriptors further indicate the length of the one or more memory locations available for storage.

7. The integrated circuit of claim 6, wherein the one or more packet descriptors indicates the length of the stored one or more received ingress packets.

8. The integrated circuit of claim 1, wherein said controller is operative to measure a volume of network signal traffic and in response thereto adjust the number of ingress packets transferred to host memory in a single memory transfer operation.

9. The integrated circuit of claim 8, wherein the memory transfer operation comprises a direct memory access (DMA) bus transaction.

10. A network adapter comprising:
a transceiver operative to receive packets via a network; and
a controller operative to retrieve from a host computing device memory one or more buffer descriptors that indicate one or more memory locations of the host memory available for storage, said controller operative to store one or more packets received via the network in the one or more memory locations indicated and to store one or more packet descriptors that indicate the location within the host memory of the one or more received packets.

11. The network adapter of claim 10, wherein the controller is operative to store multiple packets in multiple memory locations indicated by the buffer descriptors with a single memory transfer operation.

12. The network adapter of claim 11, wherein the memory transfer operation comprises a direct memory access (DMA) bus transaction.

13. The network adapter of claim 10, wherein the controller is operative to store the one or more packet descriptors into host memory using a single memory transfer operation.

14. The network adapter of claim 13, wherein the memory transfer operation comprises a direct memory access (DMA) bus transaction.

15. The network adapter of claim 10, wherein the one or more buffer descriptors further indicate the length of the one or more memory locations available for storage.

16. The network adapter of claim 15, wherein the one or more packet descriptors indicates the length of the stored one or more received packets.

17. The network adapter of claim 10, wherein said controller is operative to measure a volume of network signal traffic and in response thereto adjust the number of packets transferred to host memory in a single memory transfer operation.

18. The network adapter of claim 10, wherein said network adapter is coupled to a computing device including a host memory.

19. A method of transferring one or more ingress packets received via a network to a host memory on a computing device comprising:
storing in one or more memory locations one or more buffer descriptors indicating one or more buffers available for ingress packet storage;
storing the one or more ingress packets in the one or more buffers in host memory indicated by the one or more buffer descriptors; and
storing in another one or more memory locations one or more packet descriptors indicating the one or more buffers in host memory containing the stored one or more ingress packets.

20. The method of claim 19, wherein storing the one or more ingress packets in one or more buffers in host memory occurs in a single memory transfer operation

21. The method of claim 20, wherein the memory transfer operation comprises a DMA bus transaction.

22. The method of claim 19, wherein storing the one or more packet descriptors in the another one or more memory locations occurs in a single memory transfer operation.

23. The method of claim 22, wherein the memory transfer operation comprises a DMA bus transaction.

24. An article comprising: a storage medium, said storage medium having stored thereon instructions, that, when executed result in:
storing in one or more memory locations one or more buffer descriptors indicating one or more buffers available for ingress packet storage;
storing the one or more ingress packets in the one or more buffers in host memory indicated by the one or more buffer descriptors; and
storing in another one or more memory locations one or more packet descriptors indicating the one or more buffers in host memory containing the stored one or more ingress packets.

25. The article of claim 24, wherein, the instructions, when executed, further result in storing the one or more ingress packets in one or more buffers in host memory occurring in a single memory transfer operation.

26. The article of claim 25, wherein the memory transfer operation comprises a DMA bus transaction.

27. The article of claim 24, wherein the instructions, when executed, further result in storing the one or more packet descriptors in the another one or more memory locations occurring in a single memory transfer operation.

28. The article of claim 27, wherein the memory transfer operation comprises a DMA bus transaction.
